(19) United States
(12) Patent Application Publication
(10) Pub. No.: US 2002/0077862 A1
(43) Pub. Date: Jun. 20, 2002

(54) System for processing and customizing ventilator information

(76) Inventors: John E. Auer, Ipswich, MA (US); Paul Gilman, Gloucester, MA (US); Mark Penny, Salem, MA (US)

Correspondence Address: Siemens Corporation, Intellectual Property Department, 186 Wood Avenue South, Iselin, NJ, 08830, US

(21) Appl. No.: 09/990,939

(22) Filed: Nov. 17, 2001

Related U.S. Application Data
(60) Provisional application No. 60/249,573, filed on Nov. 17, 2000.

(51) Int. Cl. G06F 17/60

(52) U.S. Cl. 705/3

(57) ABSTRACT

A network compatible user interface system is presented for displaying patient medical parameters and supporting user customization of medical parameter image displays. The system comprises a display generator for generating a customization menu incorporating a first window including fields for user entry of items including a label identifying a medical parameter, a value of the medical parameter and a unit of measure of the parameter; a new image menu displays a value of the parameter identified by the user entered parameter label, the value being derivable from user data entry via the customization menu and from network sources, where the new image menu is displayable in response to user selection of a displayed icon. An acquisition processor communicates with network sources to acquire the medical parameter values from a network source.

This application claims the benefit of provisional U.S. application, U.S. Serial No. 60/249,573 entitled “Ventilator Input” filed Nov. 17, 2000.

### FIELD OF THE INVENTION

This invention is related to the processing and displaying of medical information, and more particularly to processing, customizing and displaying of ventilator data in a network environment.

### BACKGROUND OF THE INVENTION

In hospitals and other health care environments, it is often necessary or desirable to collect and display a variety of medical data associated with a patient. Such information may include laboratory test results, care unit data, diagnosis and treatment procedures, and ventilator information associated with a given patient. Ventilators are commonly used to ventilate a patient's lungs with breathing gas, so as to assist a patient when the patient's ability to breathe on his or her own is somehow impaired. In order to properly administer the ventilator, a caregiver must first set up various settings for the ventilator. Examples of commonly required settings to control a ventilator include: Peak Inspiratory Pressure (PIP) setting—limiting the peak pressure during inspiration of air; and Positive End Expiratory Pressure (PEEP) setting—limiting the peak pressure at the end of expiration of air. Many other ventilator settings may also be controlled, depending on the capability of the particular ventilator.

In addition, some ventilators are equipped with various sensors so that a patient caregiver may monitor the condition of the patient through the ventilator. Examples of commonly monitored parameters for a ventilator include Mean Airway Pressure (MAP)—the mean pressure measured within the airway during the breathing cycle; and Tidal Volume Inspired (TVi)—measured volume of gas inhaled by the patient during a normal breath. Many other ventilator parameters may also be monitored, depending on the sophistication of the ventilator.

The ability to set and adjust ventilator parameters and parameter settings, view default parameters, and customize these parameters and settings is of great importance to caregivers, who rely on monitored medical data to assist in the diagnosis, evaluation and treatment of patients. An apparatus and method for providing a faster, more effective and user friendly means for accessing, updating, customizing, and displaying patient medical parameters derived from a plurality of sources is highly desired.

### SUMMARY OF THE INVENTION

A network compatible user interface system is presented for displaying patient medical parameters and supporting user customization of medical parameter image displays. The system comprises a display generator for generating a customization menu incorporating a first window including fields for user entry of items including a label identifying a medical parameter, a value of the medical parameter and a unit of measure of the parameter; a new image menu displays a value of the parameter identified by the user entered parameter label, the value being derivable from user data entry via the customization menu and from network sources, where the new image menu is displayable in response to user selection of a displayed icon. An acquisition processor communicates with network sources to acquire the medical parameter values from a network source.

In another aspect, the system of the present invention comprises a network compatible user interface system for displaying patient medical parameters and supporting user customization of medical parameter image displays, comprising a display generator for generating, a customization menu comprising a composite window incorporating, a first window including fields for user entry of items including, a label identifying a medical parameter, a value of the medical parameter and a unit of measure of the parameter, and a second window including fields for user entry of values of one or more of a predefined list of system parameters; and a new image menu for displaying values of parameters entered by a user via the customization menu in response to user selection of a displayed icon.

### BRIEF DESCRIPTION OF THE DRAWINGS

In the drawing:

FIG. 1 is a block diagram of a communication network with various devices, according to the principles of the invention.

FIGS. 2A and 2B represent flow diagrams of a system according to the present invention.

FIG. 3 shows an exemplary way of customizing parameters and settings in accordance with the present invention.

FIG. 4 shows an exemplary way of how customized parameters and settings associated with a patient and ventilator are displayed according to the present invention.

### DETAILED DESCRIPTION

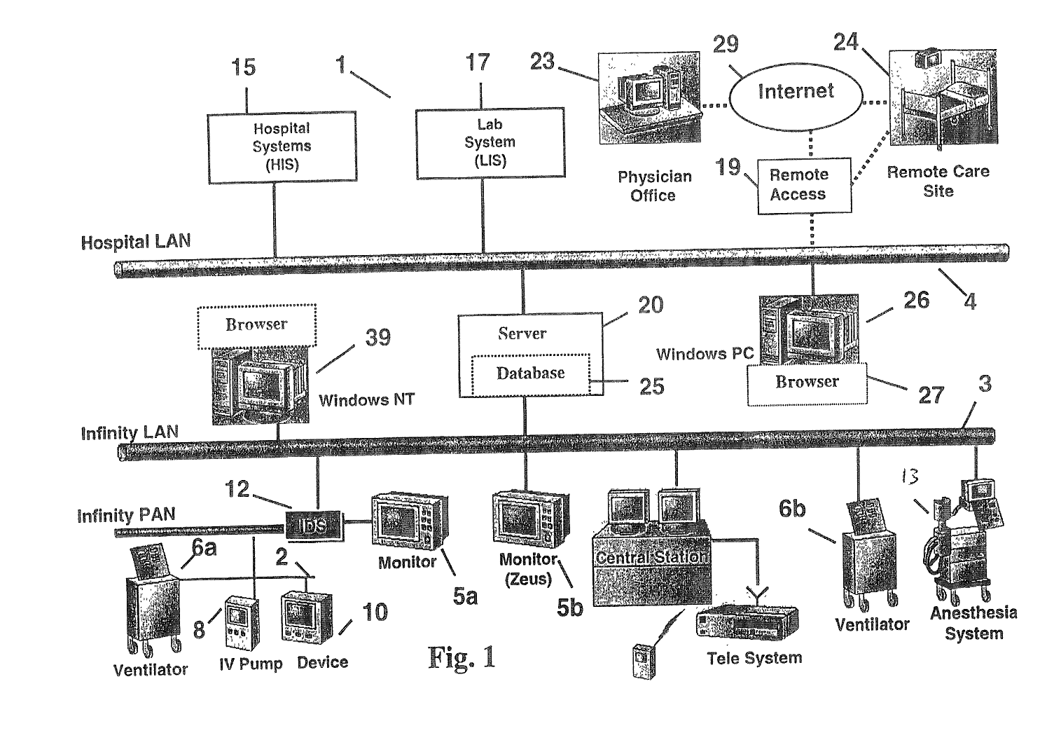

FIG. 1 is an exemplary block diagram of a communication network according to the principles of the present invention. As shown in FIG. 1, communication network 1 is represented by an IP (Internet Protocol) compatible network with a hierarchy of local area and wide area networks interconnected together. It is to be noted that although the present exemplary hospital or medical network is an IP compatible network, other types of networks such as, but not limited to optical or wireless networks, using other computing protocols such as, but not limited to, for example, X.25, frame relay, IBM SNA etc., may also be used, as one skilled in the art can readily appreciate. In addition, although the exemplary network described is a hierarchical network, this is not required by the present invention. Any type of network architecture that provides communication connectivity among the devices on the network may be used.

As shown on FIG. 1, the first level of the exemplary hierarchical network 1 comprises a Medical Interface Bus (MIB) 2. A MIB is a well-known medical industry standard for locally connecting medical devices together. As shown in FIG. 1, MIB 2 is typically used to interconnect medical devices in a patient's room to administer care to a particular patient and to monitor the particular patient. Various medical devices may be connected via MIB 2; examples shown in FIG. 1 comprise a ventilator 6a, IV (Intravenous) Pump 8 or other medical equipment 10.

MIB 2 is typically connected to a second level LAN network 3 through an Interface Docking Station (IDS) device 12, for interfacing to Ethemet-compatible LAN network 3. The higher-level LAN 3 may be for example, an Infinity LAN, marketed by Siemens Medical System. This higher-level LAN 3 is typically, though not necessarily, used by a particular department within a hospital, such as an intensive care department or surgery department, etc., depending on the size of the organizations.

Although not shown in FIG. 1, more than one MIB may be connected to the second level LAN 3, so that more than one patient may be monitored or given care through LAN 3. In addition, medical devices may be connected directly to higher-level LAN 3. For example, as shown in FIG. 1, a ventilator 6b and an anesthesia system 13 are connected directly to LAN 3, without the need to go through a MIB.

Furthermore, LAN 3 may be interconnected to a Hospital LAN backbone 4 which also is Ethernet compatible. This backbone network 4 provides communication connectivity between various departments within a hospital or medical organization; for example, connecting hospital administrative systems 15 together with laboratory systems 17. In addition, the Hospital LAN 4 has a remote access gateway 19 which provides remote, secured access from, for example, a remote doctor's office 23 or a remote care site 24, to the various systems and devices on network 1, through for example, Internet 29. Alternatively, a remote site may also access the remote access gateway 19 directly through, for example, a dial-up telephone port, ADSL, or other types of private connection. Remote access gateway 19 may also be part of server 20, to be described below, instead of standing alone, as well know in the art.

According to the principles of the present invention, a central server 20 resides on LAN 3 for gathering and processing data from ventilators and other medical devices on network 1 for display and control. One skilled in the art can readily recognize that server 20 may reside at any level of the hierarchy of network 1, since all the different levels of LANs (e.g., 3, or 4), as well as remote sites in FIG. 1 are interconnected together. An example of server 20, is a ChartAssist server, marketed by Siemens Medical System. The server may be hosted, for example, by a computer system that is capable of running Microsoft NT operating system.

Medical data and lab results may be continuously or periodically acquired and correlated with a given patient for storage in relational data base 25 within server 20. Data base 25 may be of the type used for storing relational data such as the Microsoft SQL server.

In one aspect of the present invention, a user may use a Microsoft Windows compatible PC 26 or Windows NT compatible PC 27 as shown in FIG. 1, or any other computers capable of running a menu generating program such as a web browser program (e.g., Microsoft Internet Explorer or Netscape Navigator, etc.) to view medical parameters and lab results information associated with a given patient. That is, a user may use a web browser on any computer, as long as a communication connection can be made to server 20, to make request and view information acquired and stored in data base 25. This is advantageous, since a doctor may for example, gain access to lab test results from, for example, a remote physician's office 23, without having to access a dedicated terminal. Of course, a user can simply use a keyboard and/or a mouse or any other user interface devices to enter a user selection or request on a user computer, as is known in the art.

Server 20 is therefore capable of formatting ventilator data to be compatible with, for example, HTML (HyperText Mark-up Language) programming language for displaying data on a web browser. The server is also responsive to, for example, HTTP (HyperText Transfer Protocol) commands originated from a user's web browser for making a request.

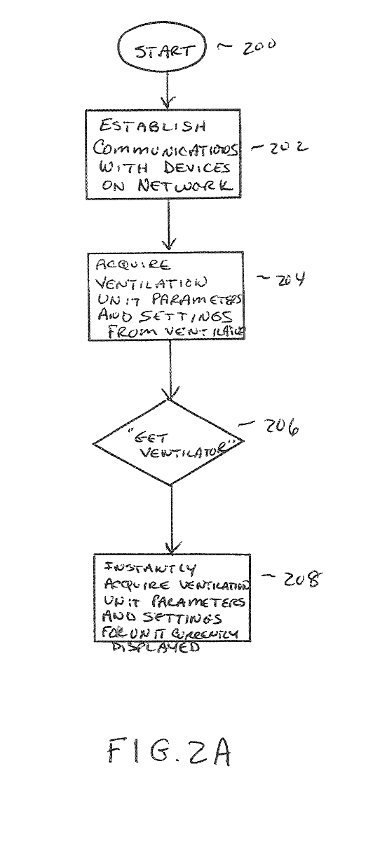

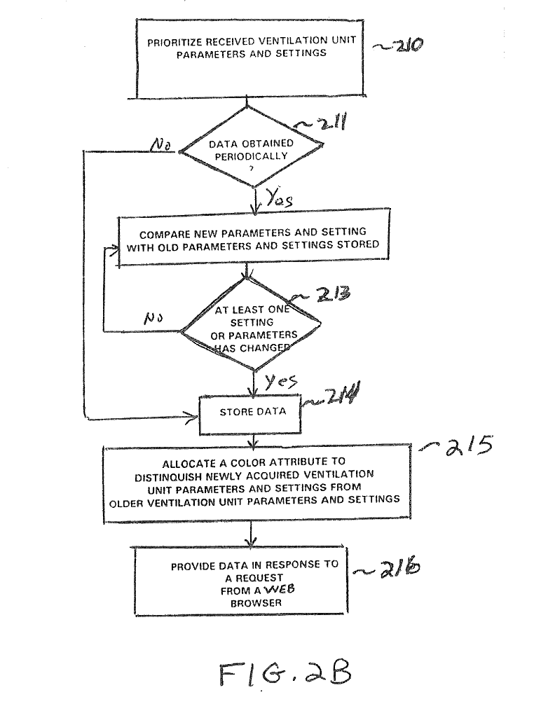

FIGS. 2A and 2B show in flow chart form, functions that may be performed by server 20 in accordance with the present invention. Server 20 first establishes communications with devices on the network as shown in step 202. This is done, for example, by using IP protocol and the known IP device address for each device on the network 1, in conjunction with a higher application-layer protocol, as well known in the art.

Once communications are established between server 20 and the other devices, server 20 starts to acquire parameters that are being monitored and settings selected for each ventilation unit (for example, 6a or 6b on network 1).

There are two different ways ventilator unit parameters and settings may be acquired by server 20 from each ventilator 6a or 6b. In step 204, ventilator data are periodically acquired from each ventilator 6a or 6b automatically. The periodically acquired data are then stored in a database 25 within the server 20. In addition, step 206 shows that a “get ventilator” request may be received by server 20 from, for example, a user computer 26 to be described in more detail later. In this case, server 20 will instantly acquire new ventilation unit parameters and settings for the unit currently being viewed by user computer 26, without waiting for the current update period to expire, as shown at step 208. This “get ventilator” feature is particularly useful when critical, real time data are needed to make quick decisions, without having to wait for the next periodic update.

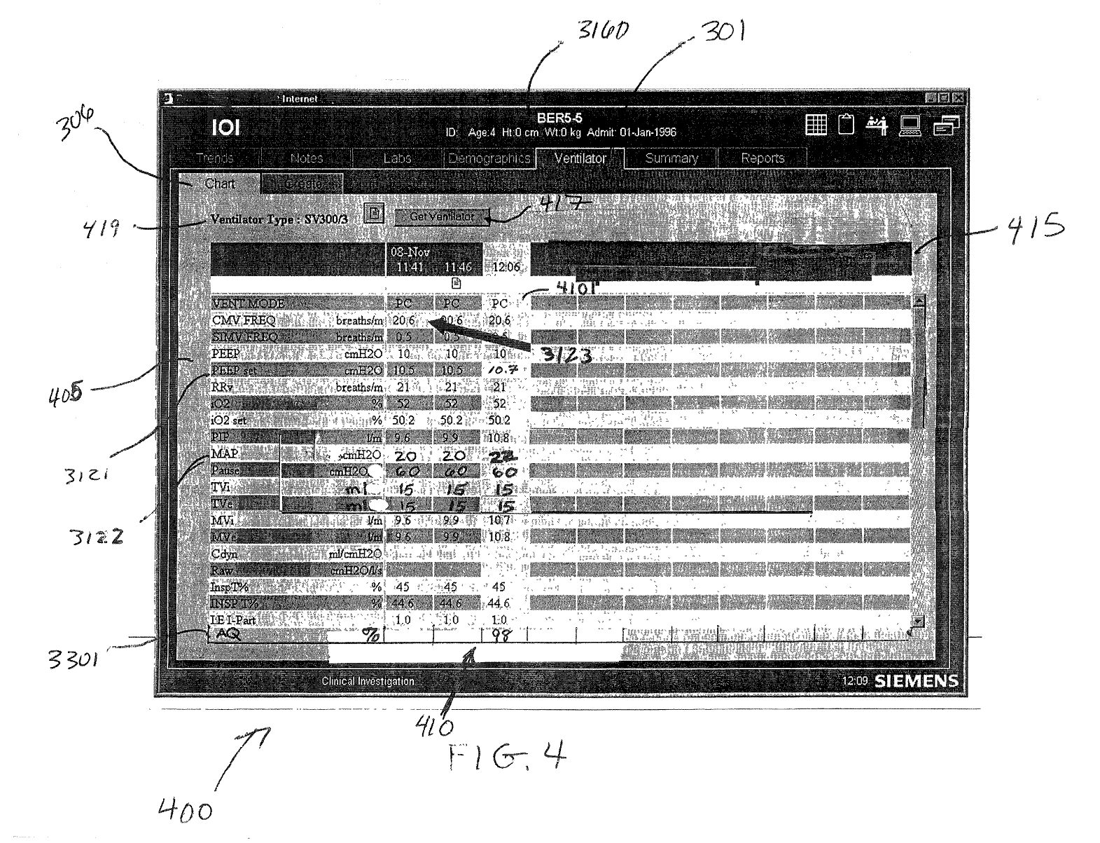

FIG. 4 shows an example of how the ventilator settings and parameters may be displayed on a web browser of a user computer 26, according to the present invention. A user may request access to a particular ventilator by, for example, specifying the name of a particular patient or bed on the network (e.g., BER or IOI Bed 5) and by selecting on ventilator tab 301. An exemplary ventilator image chart display 400 is shown in FIG. 4 when the user selects chart icon 306. Exemplary image menu chart 300 displays, on the left most column, names of the ventilator unit parameters and settings 405 being displayed. The values of these parameters and settings are shown in the rest of the columns 410 in time sequence order. The time when each value was sampled is specified in the upper row 415. A “get ventilator” function may be requested to obtain ventilator data. This function may be requested by user selecting “get ventilator” icon 417 in FIG. 4. In an exemplary embodiment, “get ventilator” icon 417 will only be active and capable of being selected on user computer 26 when the specified ventilator is recognized on hospital network 1 by server 20.

The displayed ventilator data are additionally processed by server 20 as described in FIG. 2B. As shown in step 210 of FIG. 2B, once ventilator unit data are obtained from a particular ventilator unit such as ventilator 6a or 6b shown in FIG. 1, either instantly or periodically as described before, server 20 will prioritize the received ventilation unit parameters and settings for the particular ventilator. The server prioritizes the ventilator data in response to user request and customization of data on a web browser on, for example, computer 26 to be described in more detail below.

In step 212, if data are obtained periodically, server 20 will compare newly acquired parameters and settings with existing or old parameters and settings stored in database 25. New data will be stored in database 25 for display only if at least one ventilator setting or parameter has changed, as shown in steps 213 and 214. This would allow more efficient use of database and bandwidth. However, if data are obtained in response to “get ventilator” command, Server 20 will store the data, without doing any comparison to see whether data have changed or not, as shown in steps 211 and 214.

In an exemplary embodiment, it is understood that ventilator parameters tend to change frequently (for example, TVi may changed for each inhalation by a patient), but on the other hand, ventilator settings tend to change infrequently. Therefore, it may be more informative and instructive for a caregiver if data are displayed periodically (i.e., with changes highlighted) only if at least one of the ventilator settings, not parameters have changed. Therefore, in one alternative embodiment of the present invention, as shown in step 213, ventilator data will only be stored for display, if at least one ventilator setting has changed, regardless of whether any of the ventilator parameters has changed.

In step 215, server 20 will then allocate an attribute to distinguish newly acquired ventilation unit parameters and settings that have changed from older ventilation unit and parameters and settings. One exemplary attribute may be display color. That is, when the ventilator image chart shown in FIG. 4 is requested to be displayed via computer 26, ventilator data will be color coded on the web browser so that the user is able to distinguish what new data have changed. For example, as old data that are displayed on the screen in one color (e.g., black) and carried forward to the left in each column as time advances, any newly acquired data that have changed will be displayed in another color (e.g., blue), in the column representing the current time.

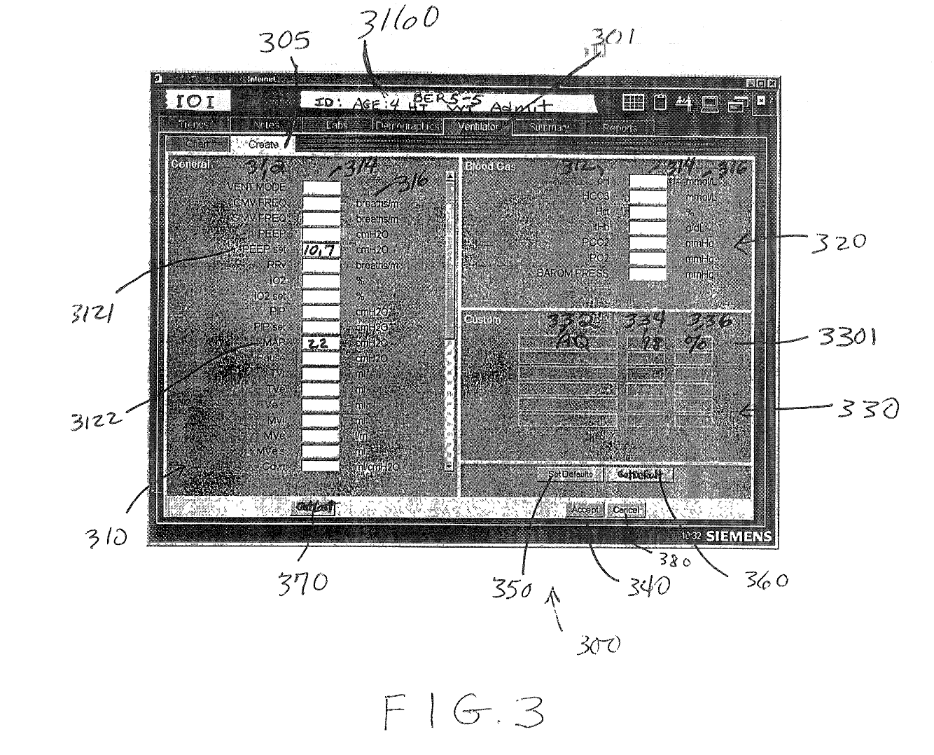

Referring now to FIG. 3, there is provided an exemplary illustration of a user interface customization screen 300 displayable on a web browser of a user computer for integrating data acquired from multiple sources, including manual entry, into a single customizable display. In general, customization display 300 accepts the manual entry of two classes of data, the first class comprising system parameter data, obtainable for example, via network sources such as the ventilator unit or monitoring device associated with a given patient at the bedside, and the second class comprising user-defined custom parameters. Three primary control functions, Get Last control (370), Set/Get Defaults control (350/360) and Accept control (340) enable a user to manage repetitive entry of manually entered data for both system and the user defined classes of data.

As shown in FIG. 3, access to the customization screen display 300 is accomplished via user selection of the Ventilator→Create tabs (301, 305). User acceptance of the values entered on the screen stores the entered values in the data base 25 and causes retrieval of these values for display as a single column entry (e.g. 4101) in ventilator image chart display 400 (FIG. 4).

An exemplary illustration of the network compatible user interface system for displaying patient medical parameters and supporting user customization of medical parameter image displays according to an aspect of the present invention is described herein. As previously mentioned, customization of data may be provided through a web browser on a user computer in response to a user request via Ventilator→Create tab selection for displaying customization screen 300. As shown therein, display 300 includes various ventilator parameters and settings for a selected ventilator associated with patient 3160. Customization menu 300 incorporates a first window portion 310 containing system parameters including general ventilation parameters and settings and a second window portion 320 containing blood gas parameters and settings. A third window portion 330 includes custom parameters presented in a three field row. As illustrated in window portions 310, 320, general ventilation parameters and settings and blood gas parameters and settings comprise a parameter label 312, a value entry field 314, and a system unit of measure 316. The value field 314 represents the only user entry field within window portions 310, 320. Parameter labels 312 and units of measure 316 represent static parameters and/or settings contained within the database 25 and displayable on screen 300. The customization parameter window portion 330 comprises parameter/setting label field 332, parameter/setting value field 334 and parameter/setting unit of measure 336. Note that each of fields 332, 334, and 336 permit user entry. Subsequent rows within window portion 330 enable user entry of additional custom parameters, values and units of measure for later retrieval and display via both customization screen 300 and ventilator image chart display 400. This is advantageous, for example, for displaying certain parameters and settings of a ventialtor or ventilator parameter that are not recognized via the system but can be acquired at the bedside of a given ventilator.

Upon entry of custom parameters/settings, values, and units (332, 334, 336) and selection of the accept control function 340, the newly created parameters are saved to the database 25 as default parameters that are then retrieved and displayed each time the Create Ventilator input screen tab (301, 305) is accessed. In addition, web browser display generator software operates in response to user acceptance (340) by requesting and displaying the newly created/updated parameters or settings in ventilator image chart display 400, along with all other acquired ventilator parameters and settings from the network associated with the given patient.

Selection of the Set Defaults control function 350 operates to store in the database those user entered custom parameters/values/units in window portion 330 for later access and retrieval via the Get Defaults control function 360. The Get Last control function 370 is responsive to user selection for retrieving from database 25 the last saved set of General, Blood Gas, and Custom values and parameter settings for display in the corresponding window portions 310, 320, 330 as a starting point for current entry and update. These values may be edited and then saved as a new ventilator chart image entry on ventilator chart image display 400 (FIG. 4). As previously mentioned, the Accept function 340 operates to save the current displayed data contained in window portions 310, 320 and 330 as a new chart entry in the ventilator image chart display 400. More particularly, user entry and/or modification of data parameters/settings associated with each of the data parameter values 314 and custom parameters/settings 332, 334, 336, and selection of the Accept control function results in a new column 4101 of parameter data generated and displayed in ventilator chart image display 400 corresponding to the manually entered values as well as any values maintained from the ventilator source. The selection of the cancel control function 380 operates to exit the customization screen 300 without saving the displayed data.

As shown in FIG. 4, the ventilator chart image display 400 operates to display values of parameters identified by the user entered parameter labels where the values are derivable from both user data entry via the customization menu 300 (FIG. 3) as well as from network sources such as the ventilator or monitoring device attached to the patient via the network. The ventilator chart image display 400 is activated in response to user selection of ventilator tab/icon 301 and chart sub tab 306. As previously mentioned, ventilator chart image display 400 is also activated in response to selection of the accept control function 340 (FIG. 3) which causes the system to obtain and display new ventilator data analagous to the “get ventilator” function previously described. Column 4101 (FIG. 4) illustrates the results of such a selection, which includes manually updated setting values for PEEP set 3121 (value 10.7), MAP parameter 3122 (value 22) and newly created AQ custom parameter 3301 and corresponding value 98. In addition, the system of the present invention acquires and displays in new column 4101 all other settings and parameters (e.g. 3123) associated with the given ventilator unit 419 and patient 3160.

It is to be understood that the embodiments and variations shown and described herein are for illustrations only and that various modifications may be implemented by those skilled in the art without departing from the scope of the invention.

What is claimed is:

1. A network compatible user interface system for displaying patient medical parameters and supporting user customization of medical parameter image displays, comprising:
a display generator for generating,
a customization menu incorporating a first window including fields for user entry of items including, a label identifying a medical parameter, a value of said medical parameter and a unit of measure of said parameter;
a new image menu for displaying a value of said parameter identified by said user entered parameter label, said value being derivable from user data entry via said customization menu and from network sources, said new image menu being displayable in response to user selection of a displayed icon; and
an acquisition processor for communicating with network sources and acquiring said medical parameter value from a network source.

2. The system of claim 1, wherein said network is at least one of (a) internet and (b) intra-net compatible.

3. The system of claim 1, wherein a previously stored parameter value is retrieved for display in said new image menu.

4. The system of claim 1, wherein said medical parameter comprises a parameter or device setting associated with a ventilation function.

5. The system of claim 1, wherein said customization menu is a composite window including a window permitting user entry of values for one or more of a predefined list of parameters.

6. The system of claim 5, wherein said predefined list includes ventilation parameters and settings.

7. The system of claim 5, wherein said predefined list further includes blood gas parameters.

8. The system of claim 1, wherein said display generator is an internet browser.

9. The system of claim 1, wherein said customization menu includes a first user-selectable controller for retrieving and displaying the values of the last saved set of parameters and settings associated with a predefined listing stored in a data base.

10. The system of claim 9, wherein said customization menu further includes a second user-selectable controller for storing newly entered values associated with said predefined listing of parameters and settings.

11. A network compatible user interface system for displaying patient medical parameters and supporting user customization of medical parameter image displays, comprising:
a display generator for generating,
a customization menu comprising a composite window incorporating,
a first window including fields for user entry of values of one or more of a predefined list of system parameters; and
a second window including fields for user entry of items including, a label identifying a medical parameter, a value of said medical parameter and a unit of measure of said parameter, and
a new image menu for displaying values of parameters entered by a user via said customization menu in response to user selection of a displayed icon.

12. The system of claim 11, wherein said predefined list of parameters comprises parameters associated with one of (a) ventilation function and ventilation device settings and (b) blood gas characteristics.

13. The system of claim 11, further including an acquisition processor for communicating with network sources and acquiring a customization menu defined parameter from a network source.

14. A network compatible user interface system for displaying patient medical parameters and supporting user customization of medical parameter image displays, comprising:
a display generator for generating a composite window incorporating,
a first window including fields for user entry of values of one or more of a predefined list of system parameters; and
a second window including fields for user entry of items including, a label identifying a medical parameter, a value of said medical parameter and a unit of measure of said parameter, and
a new image menu for displaying values of parameters entered by a user via said customization menu in response to user selection of a displayed icon; and
an acquisition processor for communicating with network sources and acquiring said medical parameter value from a network source, wherein said new image menu is operative to display both user-entered parameter values as well as parameter values previously acquired and stored in a data base via said processor.

15. The system of claim 14, wherein said medical parameter comprises a parameter or device setting associated with a ventilation function.

16. The system of claim 14, wherein said medical parameters and settings are displayed so that changed parameters and changed settings are displayed in a different color.
